(19) United States
(12) Patent Application Publication
(10) Pub. No.: US 2004/0021281 A1
(43) Pub. Date: Feb. 5, 2004

(54) Skateboards

(76) Inventor: Odell Stephens JR., Morton, PA (US)

Correspondence Address: ODELL STEPHENS JR., 15 AMOSLAND ROAD, MORTON, PA, 19070, US

(21) Appl. No.: 10/094,224

(22) Filed: Aug. 1, 2002

(51) Int. Cl. B62M 1/00

(52) U.S. Cl. 280/87.042

(57) ABSTRACT

A skateboard comprising an elongated generally rectangular base, front and rear wheel assemblies engagable with a flat planar surface and a swivel wheel mounted at at least one terminal end of the skateboard which spaced upwardly from a support surface in which the board is used when the front and rear wheel assemblies engage the surface.

### FIELD OF THE INVENTION

The present invention relates to an improvement in a skateboard characterized by novel features of construction and arrangement providing additional interesting maneuvers by reason of the new and improved construction.

### BACKGROUND OF THE INVENTION

Skateboards are not new per se. Presently, the skateboard designs typically comprise an elongated generally rectangular base or platform which is turned up at its opposite terminal ends and front and rear wheel assemblies. Typically skilled users are able to perform many interesting maneuvers on skateboards utilizing the upwardly curved front and rear portion to position the board at various attitudes.

In-line skates comprises a series of wheels one behind the other. The skates usually include a protrusion in the rear providing braking action when engaged on a riding surface such as a pavement or a street.

### SUMMARY OF THE INVENTION

The present invention adds to the conventional skateboard an additional wheel which preferably swivels mounted at one end of the skateboard base which normally when the front and rear wheels are on a flat surface is spaced upwardly from that surface and does not engage the surface so that the user can tilt the board to engage the fifth wheel and execute interesting spin maneuvers.

### BRIEF DESCRIPTION OF THE DRAWINGS

These and other objects of the present invention and the various features and details of the operation and construction thereof are hereinafter more fully set forth with reference to the accompanying drawings, wherein:

FIG. 1 is a perspective view of a skateboard incorporating the improvement of the present invention;

FIG. 2 is a bottom plan view showing the wheel configuration of the improved skateboard.

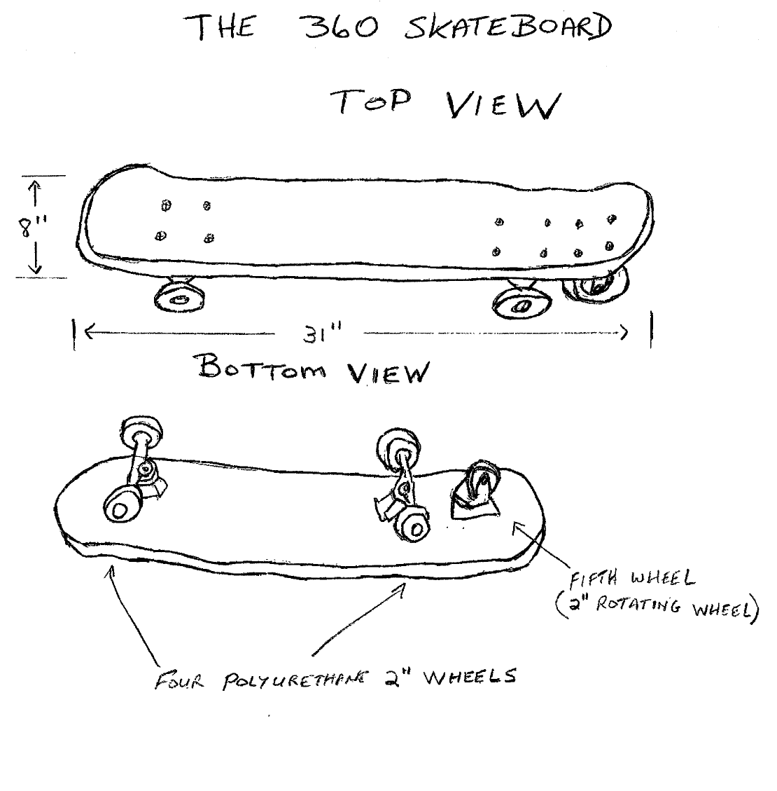

### DETAILED DESCRIPTION OF THE PREFERRED EMBODIMENT

Referring now to the drawing, there is shown a skateboard 10 generally designated by numeral 10 incorporating the improvement of the present invention. The skateboard 10 comprises a generally elongated rectangular base 12 which may be made of any suitable material including plastics and front and rear wheel assemblies 14 and 16. The base 12 has an upwardly turned outer terminal ends as at 18 and 20 so that the board can be selectively tilted by the user to execute various maneuvers. In a typical case, the skateboard 10 is about 32″ long and 8″ wide. Typically, the wheel assemblies 14 and 16 are also plastic. The main wheels are mounted on axles 22 and 24 extending generally transversely to the base 12 of the skateboard.

In accordance with the present invention, there is provided at least one additional wheel 26 mounted at one or both ends of the base 12 of the skateboard 10 which preferably is free to swivel through 360° and is normally spaced upwardly a predetermined distance from a flat planar surface when the front and rear wheels 14 and 16 are engaging the surface so that when the user desires to execute a spin maneuver, in this instance, the front end 20 is tilted by the user to engage the spin wheel on the riding surface and in this position the user can execute a spin much like spins executed by ice skaters.

What is claimed is:

1. A skateboard comprising an elongated generally rectangular base, front and rear wheel assemblies engagable with a flat planar surface and a swivel wheel mounted at at least one terminal end of the skateboard which spaced upwardly from a support surface in which the board is used when the front and rear wheel assemblies engage the surface.
